(19) United States
(12) Patent Application Publication
(10) Pub. No.: US 2002/0014264 A1
(43) Pub. Date: Feb. 7, 2002

(54) Apparatus and method for seismic event activated automatic gas shut-off valve

(76) Inventor: Hugh W. Crane, Marion, IL (US)

Correspondence Address: George L. Williamson, P.O. Box 508, Fairhope, AL, 36533, US

(21) Appl. No.: 09/862,120

(22) Filed: May 21, 2001

Related U.S. Application Data
(60) Provisional application No. 60/205,919, filed on May 22, 2000.

(51) Int. Cl. F16K 17/36

(52) U.S. Cl. 137/38

(57) ABSTRACT

The present invention discloses an automatic gas shut-off valve which has associated therewith a seismic sensor unit. The seismic sensor unit can be either an electric unit or mechanical unit or both. In operation, the seismic sensor is triggered by a seismic event to the dump/default or shut-off position whereupon the seismic sensor then causes the automatic gas shut-off valve to close and remain closed, thereby stopping the potential continued release of gas. The electric seismic unit with user reset can be located within the protected confines of a structure in a manner similar to today's electric circuit breaker box. This systems allows the consumer to restore gas to his own structure after determining that the gas lines and appliances are safe and undamaged, just as can be done with a tripped electric circuit breaker, without having to call in the utility company.

### BACKGROUND OF THE INVENTION

This application claims benefit of U.S. provisional application Ser. No. 60/205,919 filed on May 22, 2000.

### FIELD OF THE INVENTION

The present invention relates generally to shut-off valves and, more particularly, is concerned with an automatic gas shut-off valve with a seismic sensor unit serving the purpose of enhancing personal and public safety when utilizing gas service at and within inhabited structures.

### DESCRIPTION OF THE PRIOR ART

Shut-off valves have been described in the prior art. However, none of the prior art devices disclose the unique features of the present invention.

In U.S. Pat. No. 4,969,482 dated Nov. 13, 1990, Perrin, et al., disclosed a reusable emergency gas shut-off valve for terminating the supply of fuel to a dwelling which is adapted for fluid pressure actuation at a location outside of the dwelling, manual actuation on the valve itself, and thermal actuation from heat in the vicinity of the valve or via a signal received from a temperature-sensing device at a location remote from the valve. The valve is resettable only by utilizing a specially constructed reloading tool.

In U.S. Pat. No. 5,730,170, dated Mar. 24, 1998, Sanchez disclosed an emergency fuel shutoff device for interrupting the flow of gas or other fuel to a burner in the event of a malfunction or fire. The device uses a normally closed spring loaded fuel valve which is held open by tension along a cable. The cable has several fusible links along its length. If any of the fusible links melt, the tension in the chain is released and the spring-loaded fuel valve closes, shutting off the flow of fuel to the burner. Preferably the device also has a manual shut-off station which has a pull ring which also releases the tension in the cable shutting off the flow of fuel. When the tension in the cable is released a horn or strobe light provides an audible and a visible signal that the fuel valve has been closed. The horn and light are preferably powered by standby batteries.

In U.S. Pat. No. 4,825,649, dated May 2, 1989, Donnelly, et al., disclosed fuel which is directed to the stages of an afterburner by metering flow to the stages with a single metering valve and by controlling the flow to each stage by means of an integral shutoff and regulating valve. Each shutoff valve opens and closes the fuel flow to a stage as required. Each regulating valve, which is housed within a respective shutoff valve, regulates flow to each segment as a function of the pressure drop across the metering valve so that a constant weight flow to the segment is achieved.

In U.S. Pat. No. 5,114,115, dated May 19, 1992, Gillott disclosed a fuel management system shutoff means in a fuel supply line which closes when the pressure at a port on the shutoff means exceeds some predetermined level. A most selector valve attached to the port connects to two electrically and mechanically independent shutdown valves. Actuating either valve pressurizes the port, closing the shutoff means and stopping all flow through the supply line.

In U.S. Pat. No. 4,721,128, dated Jan. 26, 1988, Padilla disclosed a pressure chamber through which the fuel in the fuel line passes, having a diaphragm moving to advanced position by the pressure in the chamber. A PE cell is arranged with light rays passing through the camber and when the diaphragm is retracted it breaks the light rays and shuts off the circuit but when it is advanced the light rays are not broken and the circuit is energized. A valve in the fuel line has a closer which is moved to closed position when the circuit is de-energized and it remains closed until opened manually for resetting the circuit.

In U.S. Pat. No. 5,388,622, dated Feb. 14, 1995, Phillips disclosed a two-stage float actuated shut-off valve for use in underground fuel storage tanks which utilizes a drop tube coaxially mounted within the storage tank fill pipe. Fuel flowing into the tank is passed through the drop tube which projects downwardly into the interior of the tank to a valve housing located at the lower end of the drop tube. Floats slidably mounted in a recessed area in the housing outside of the drop tube within the tank independently operate pivoted valve doors to a closed position within the valve housing, a lower float closing one valve door to block a major portion of incoming fuel flow passage when the level of fuel in the storage tank reaches a predetermined first level and a second upper float causing the secondary valve door to overlap an aperture in the main valve door to almost completely close the flow of fuel to the tank.

In U.S. Pat. No. 5,409,370, dated Apr. 25, 1995, Henderson disclosed a safety device for preventing uncontrolled burning in wick-fed liquid fuel burners which employs an excess fuel containment compartment which receives any excess fuel which might be fed from a removable tank through a spring-loaded valve in the removable tank cap into fuel supply chamber. The excess fuel causes a receptacle in the compartment to move downward. Through a retaining arm and level such movement activates a pin-drop mechanism. Activation of the pin-drop mechanism closes off the valve in the removable tank cap. Also the mechanism prevents re-opening of the fuel tank valve until the danger of flare-up is removed. This safety device also alerts the user of the liquid fuel burner to a dangerous condition by a mechanism comprising a warning gauge needle. In addition, the burner can be readily serviced and restored to operation should an excess fuel malfunction occur.

In U.S. Pat. No. 5,439,023, dated Aug. 8, 1995, Horikawa disclosed a shut-off valve for a liquid fuel which includes a valve housing in which a float, adapted to be raised by buoyant force as the liquid fuel flows into the valve housing, and a valve disc, for sealably closing a fuel vapor outflow hole, are arrange din such a manner as to allow the valve disc to be vertically displaceable relative to the float. A plate-like valve member, which carries a rod-shaped protuberance for sealable closing a through hole formed through the valve disc, is disposed between the valve disc and the float. When the float is lowered as the liquid fuel returns from the valve housing to the fuel tank, a first engagement pawl engages the plate-like valve member at a single point and, at the same time, a second engagement pawl engages a flange portion of the valve disc at a single point, whereby the plate-like valve member and the valve disc are opened so as to enable the fuel vapor generated in the fuel tank to flow into a receiving canister. At the time of an occurrence of vehicular accident or emergency, a ball member disposed in the valve housing is slidably displaced along a concave conical surface until the fuel vapor outflow hole is sealably closed by the valve disc via the ball member, thus preventing the liquid fuel from flowing into the canister.

While shut-off valves may be suitable for the purposes for which they were designed, they would not be as suitable for the purposes of the present invention, as hereinafter described.

### SUMMARY OF THE INVENTION

The present invention discloses an automatic gas shut-off valve which has associated therewith a seismic sensor unit. The seismic sensor unit can be either an electric unit or mechanical unit or both. In operation, the seismic sensor is triggered by a seismic event to the dump/default or shut-off position whereupon the seismic sensor then causes the automatic gas shut-off valve to close and remain closed, thereby stopping the potential continued gas release.

An object of the present invention is to automatically shut-off gas supply lines and/or valves or the like from various locations within a structure in the event of a seismic occurrence. A further object of the present invention is to provide an inexpensive end user operable method of shutting off gas during a seismic event and thereafter allowing the end user to reset and restore gas services to his structure after determining the safety of so doing without having to wait for gas utility crews to inspect and restore all disrupted structure.

The foregoing and other objects and advantages will appear from the description to follow. In the description reference is made to the accompanying drawings, which form a part hereof, and in which is shown by way of illustration specific embodiments in which the invention may be practiced. These embodiments will be described in sufficient detail to enable those skilled in the art to practice the invention, and it is to be understood that other enhancing embodiments may be utilized and that structural changes may be made without departing from the scope of the invention. In the accompanying drawings, like reference characters designate the same or similar parts throughout the several views.

The following detailed description is, therefore, not to be taken in a limiting sense and the scope of the present invention is best defined by the appended claims.

### BRIEF DESCRIPTION OF THE DRAWINGS

In order that the invention may be more fully understood, it will now be described, by way of example, with reference to the accompanying drawings in which:

FIG. 1 is an illustration of the present invention in a mechanical format.

FIG. 2 is an illustration of the electric seismic sensor unit of the present invention.

FIG. 3 is an illustration of the enhanced remote location user resetable electric seismic sensor unit of the present invention.

FIG. 4 is an illustration of the companion electric automatic default event gas shut-off valve with remote dump and user reset connections as a system component of the present invention.

### LIST OF REFERENCE NUMERALS

With regard to reference numerals used, the following numbering is used throughout the drawing.

1 valve body

1A gas inlet line

1B gas outline line

1C structure being fed

2 valve stem actuator base

3 valve stem actuator top

4 valve stem

4A main valve seat

5 valve stem actuator diaphragm

6 valve stem spring

7 valve stem indicator disk

8 valve stem nut

9 valve stem cover

10 valve stem diaphragm

11 valve stem packing

12 valve stem guide/packing retainer

13 valve stem seal O-ring

14 valve body O-ring

15 valve stem actuator vents

16 valve stem actuator screws

17 fittings

19 tubing

20 body

21 seismic sensor valve

22 cover

23 detector weight

24 valve shaft

25 valve seat

26 unseating ring

27 spring

28 adjustment screw

29 screw cap

30 rubber gasket

31 flange bolt hole

32 gasket

33 screws

34 micromesh

35 support ring

36 ring screw

37 electric seismic sensor

40 cover

42 box

43 base plate

44 nipple

45 nuts

46 switch

47 weight

48 terminal strip

49 copper wires

50 spacers

51 screws

52 wire shield

53 screws

54 washers

55 connectors

56 chain

57 screws

58 nuts

59 screws

60 wire spring

61 nuts

62 screws

63 nuts

64 bolt hole

65 holes

66 conduit hub

67 LED

70 remote, user resetable seismic sensor unit

71 housing box

72 housing box cover

73 unit wiring terminal strip

74 mounting screws

75 self-contained battery holder and charger

76 AA-NIMH batteries

77 case wires

78 green LED

79 yellow LED

80 red LED

81 push button reset switch

90 electric default event gas shut-off valve with seismic sensor unit with dump and user reset solenoids

91 remote seismic unit dump solenoid

92 remote seismic unit dump wire connection

93 remote seismic unit user reset solenoid

94 remote seismic unit user reset wire connection

95 manual reset access cap

### DESCRIPTION OF THE PREFERRED EMBODIMENT(S)

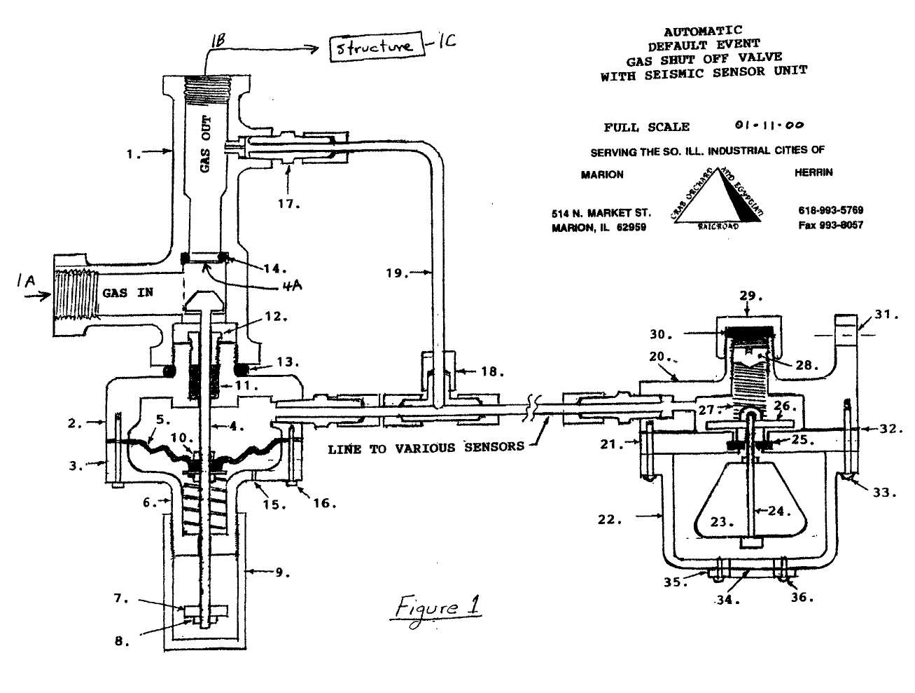

Turning now descriptively to the drawings, in which similar reference characters denote similar elements throughout the several views, FIGS. 1 through 4 illustrate the present invention wherein an automatic gas shut-off valve is disclosed.

Turning to FIG. 1, therein is shown a view of the present invention. The present invention is a low-cost yet effective device which will shut-off the gas service to any structure upon the event of one or more selected defaults; e.g., a seismic event. The main automatic gas shut-off valve 1 can be made in any of the standard supply pipe sizes and placed near gas meters, gas distribution points, gas appliances, propane tanks, etc. This valve 1, having a gas inlet 1A and outlet 1B to a fed structure 1C, is a latching valve in that it unlatches from its open position and latches shut when defaulted by any one of many sensor valves, such as the mechanical seismic sensor valve 21 as described herein. This system functions as follows: in the reset open position the main valve seat 4A is held open by positive line gas pressure flowing through tube 19 to pressurize from above the valve stem actuator diaphragm 5 thus opening valve seat 4A. Any loss of line pressure above the diaphragm 5 will cause the valve stem hold shut spring 6 to close the main valve seat 4A, thus closing off all sources of gas line pressure to the fed structure 1C and the diaphragm 5, thus the valve 1 remains latched shut. In a quake event, the line pressure to the diaphragm will be momentarily lost (dumped) when any seismic or shaking motion rocks or lifts the seismic sensor unit's motion detector valve 24 off its seat 25. Seismic sensor units 21 can be placed right at the shut-off valve 1 (as shown) or in various remote locations, as also can be fire and/or other default/detectors. Later, after the event, if gas utility personnel determine that the structure and its gas lines are safe, they can reset the valve 1 and system by removing the clear lexan indicator cover 9 and pulling the indicator 7 down momentarily to re-open valve seat 4A. This action restores gas pressure to the structure and thus to the top of the hold open diaphragm 5, providing that there were yet no undiscovered leaks or breaks in the line.

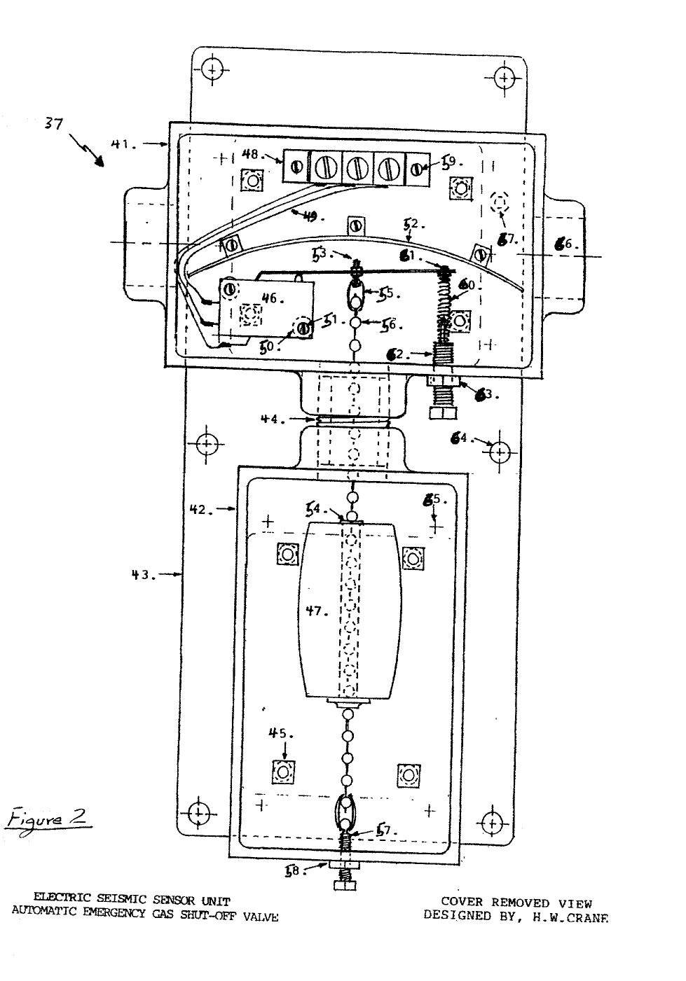

Turning to FIG. 2, therein is shown an electric seismic sensor unit 37 to be used in conjunction with the gas shut-off valve 1 of FIG. 1 or other standard solenoid gas valves. This unit 37 can be used in conjunction with the automatic emergency gas shut-off valve utilizing any standard solenoid gas valve (electro-pneumatic) designed to open upon electrical activation. This unit is designed so that an inertial mass 47 will, when acted upon by damaging level forces from earthquake/seismic events, cause the closing of a standard micro switch's 46 (normally open at rest) contacts. Upon the closing of those contacts, a circuit is completed which activates the solenoid valve (not shown) causing the instantaneous “dumping” or closing of the automatic emergency gas shut-off valve; e.g., valve 1 of FIG. 1. Seismic activity threshold (stability range), sensitivity and reaction time adjustability are all designed into the components of this seismic sensor unit using adjustments 57, 62. Thus, the gas supplier/utility can adjust the system to fit the application without compromising the speed of the reaction. This unit can be used in conjunction with and/or in place of the mechanical seismic sensor unit 21 of FIG. 1. Typically, this electric seismic sensor unit 37 would be located remotely from the automatic emergency gas shut-off valve 1, e.g., at various locations within any structure to be protected. Whereas, the mechanical seismic sensor unit 21 would typically be mounted directly to the automatic emergency gas shut-off valve 1 right at the gas meter or gas service entrance supply point. However, the design of the system components does also allow the mechanical seismic sensor unit 21 to be remotely located in cases where redundant failsafe systems are required. This unit is also designed so that it can activate 911 automatic dialers, alarms, etc., in the event of a structural collapse or failure from causes other than seismic events. An optional LED type indicator light 67 can be employed to indicate that the system is powered up and standby ready. The design and construction of this unit is totally based around existing standard gas utility “off-the-shelf” components, using standard practice technology and mid-level skilled labor for assembly.

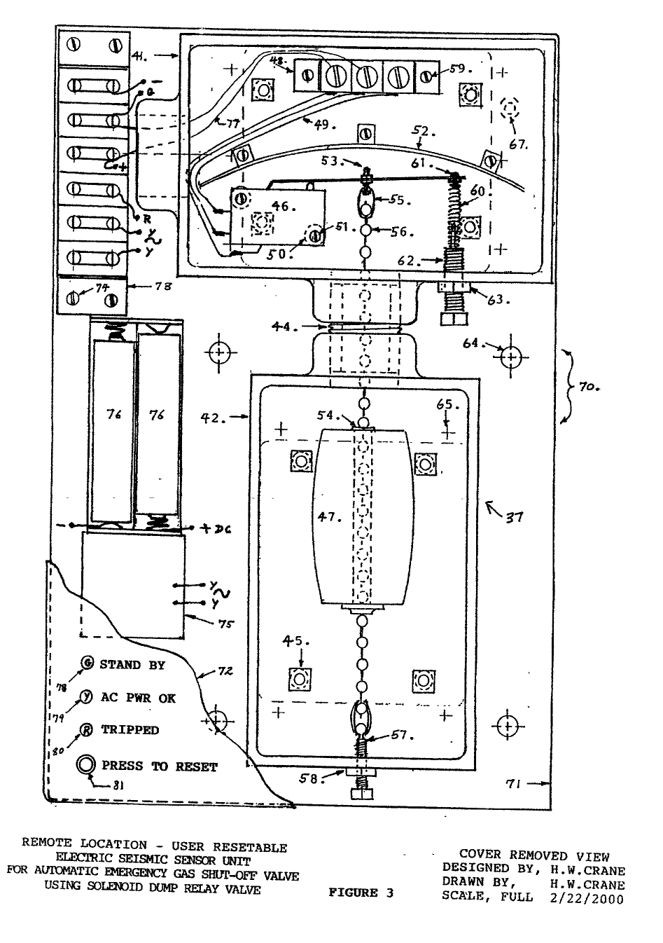

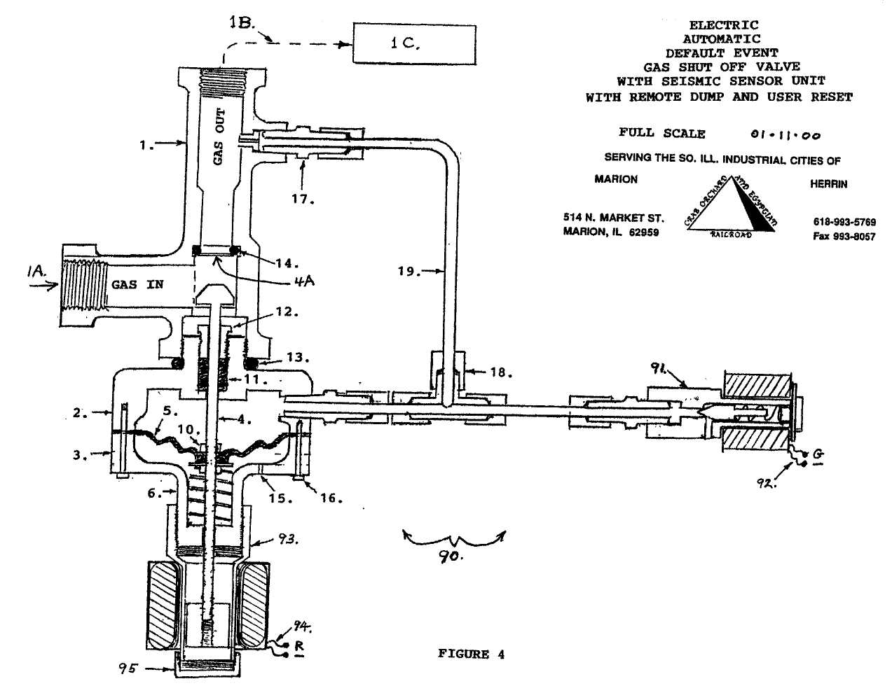

Turning to FIG. 3, therein is shown an enhanced remote location-user resetable electric seismic sensor unit for possible use with the present invention. This unit 70 is comprised of unit 37 as shown in FIG. 2, plus the electrical components that allow this unit to be end user friendly. This unit 70 has its own standby power source for the needs of unit 37 and unit 90 of FIG. 4. The components of unit 70 are contained in a utility box 71 with the user indicator LED's and controls being front mounted upon its cover 72. The principal feature of unit 70 of the present invention is that it is user resetable from its location within the system-protected structure by means of pressing the press to reset button switch 81 that electrically resets Item 1 in unit 90 of FIG. 4.

Turning to FIG. 4, therein is shown unit 90 of the present invention which is comprised of unit 1 of the present invention being enhanced with solenoids 91 and 92 which permit unit 1 to be remotely event shut (dumped) and then reset by the end user at the location of unit 70 of FIG. 3 of this present invention when deemed safe by the end user to do so. Unit 1 will not reset if lines are broken.

FIGS. 1, 2, 3 and 4 disclose numerous additional elements which are listed in the List of Reference Numerals which are not explained in detail above but which would be understood by one skilled in the art.

What is claimed to be new and desired to be protected by Letters Patent is set forth in the appended claims:

1. An apparatus for shutting off a gas valve during a seismic event, comprising:
a) means for a gas valve whereby the flow of gas is controlled; and,
b) means for shutting off said gas valve whereby the gas valve is shut off in response to a seismic event.

2. The apparatus of claim 1, wherein said means for a gas valve further comprises a gas inlet, a gas outlet, a valve seat disposed between said gas inlet and said gas outlet, a valve stem complimentarily sized and shaped for use with said valve seat, and means for a valve stem actuator diaphragm whereby the position of said valve stem is controlled.

3. The apparatus of claim 2, wherein said means for shutting off said gas valve further comprises a mechanical seismic sensor valve.

4. The apparatus of claim 2, wherein said means for shutting off said gas valve further comprises an electrical seismic sensor valve.

5. The apparatus of claim 3, wherein said mechanical seismic sensor valve further comprises means for mechanically sensing a seismic event and means for mechanically shutting off said gas valve whereby gas flow through the gas valve is stopped.

6. The apparatus of claim 4, wherein said mechanical seismic sensor valve further comprises means for mechanically sensing a seismic event and means for electrically shutting off said gas valve whereby gas flow through the gas valve is stopped.

7. The apparatus of claim 6, wherein said electrical seismic sensor valve further comprises a micro switch, a means to trigger said micro switch in response to a seismic event, and a solenoid means for shutting off said gas valve whereby the solenoid means shuts off the gas valve in response to the micro switch being triggered by a seismic event.

8. The apparatus of claim 7, further comprising means for a self-contained power supply and control means whereby the electrical seismic sensor valve can be locally reset by a user.

9. The apparatus of claim 8, further comprising means for a solenoid disposed on said gas valve whereby the gas flow through the gas valve is controlled.

10. A method for shutting off the gas flow through a gas valve during a seismic event, the gas valve being used in a gas line for supplying gas to a structure, comprising the steps of:
a) sensing the occurrence of a seismic event; and,
b) shutting off the gas flow through the gas valve after sensing the seismic event.

11. The method of claim 10, further comprising the steps of:
a) providing a mechanically operated seismic sensor valve;
b) sensing the occurrence of a seismic event; and,
c) shutting off the gas flow through the gas valve.

12. The method of claim 10, further comprising the steps of:
a) providing an electrically operated seismic sensor valve;
b) sensing the occurrence of a seismic event; and,
c) shutting off the gas flow through the gas valve.

13. The method of claim 12, further comprising the step of:
a) providing a solenoid switch for shutting off the gas valve.

14. The method of claim 13, further comprising the step of:
a) resetting the gas valve locally by resetting the electrically operated seismic sensor valve locally.

15. The method of claim 14, further comprising the steps of:
a) locating the gas valve external of the structure; and,
b) resetting the gas valve internal of the structure.
